(19) United States
(12) Patent Application Publication
(10) Pub. No.: US 2005/0002536 A1
(43) Pub. Date: Jan. 6, 2005

(54) Ultrasonic transducer

(76) Inventors: Vladimir Gorelik, Hannover (DE); Hans Kuehn, Wedemark (DE); Wolfgang Niehoff, Wedemark (DE); Rainer Wiggers, Ahlden/Eilte (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/799,255

(22) Filed: Mar. 12, 2004

(30) Foreign Application Priority Data
Mar. 13, 2003 (GB) 103 11 410.6

(51) Int. Cl. H04R 11/02

(52) U.S. Cl. 381/150

(57) ABSTRACT

An ultrasonic transducer with a diaphragm and an embossed backplate is provided. Due to the embossing of the backplate, spacer disks are no longer necessary and the efficiency of the transducer is substantially increased.

The present invention is directed to an ultrasonic transducer and to a loudspeaker with a plurality of ultrasonic transducers.

Ultrasonic transducers are used in movement sensors and distance sensors, anemometers, flow meters and in parametric loudspeakers (AudioBeam), etc. In all of these applications, the radiator is expected to achieve high efficiency, i.e., a high attainable sound pressure, in addition to good directivity. In distance sensors and flow meters, the broadbandedness of the transducers determines their accuracy.

At a determined distance r on its axis, a piston radiator oscillating in an infinite, rigid wall and having a radius a and velocity ν generates the sound pressure given by the following equation:

$$\vert p \vert = 2 pcv \vert sin [ \frac{k}{2} ( \sqrt{{r}^{2} + {a}^{2} - r} ) ] \vert \qquad ( 1 )$$

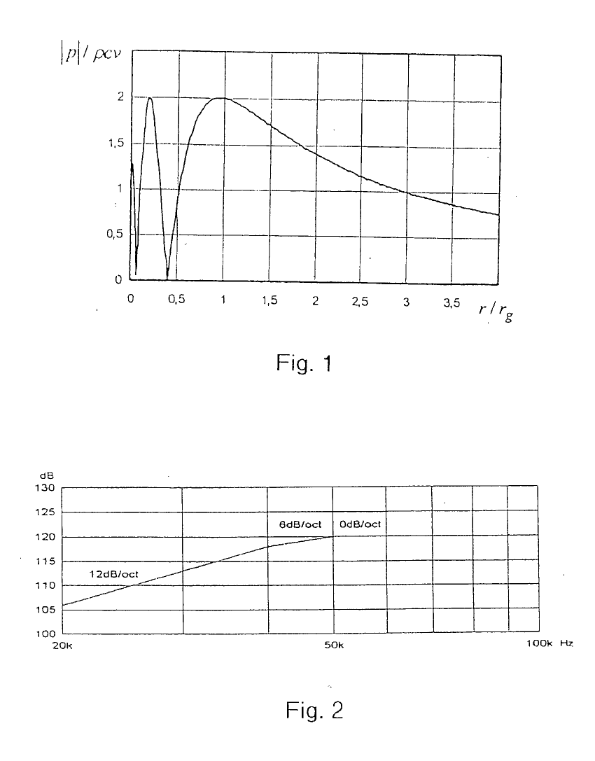

The amount of the sound pressure is considered in an analogous manner. The sound pressure curve which is calculated according to (1) and which is dependent upon the scaled distance r/r_{g}, where r_{g}=a²/λ corresponds to the distance at which the final maximum is achieved, is illustrated in FIG. 1 which shows the curve of the sound pressure.

For the far field (r>>a²/λ), equation (1) can be simplified in the following manner:

$$p = pcv ( {ka}^{2} / 2 r ) = \frac{pf υ A}{r} , \qquad ( 2 )$$

where A=2πa² is the surface of the piston.

It can be easily demonstrated that the mechanoacoustic system of the broadband transducer must be mass-inhibited: actually, the mechanical impedance Z_{M} increases in proportion to the frequency: Z_{M}=ωm, and the following holds true for the velocity: ν=F/_{ω}·m, where F is the frequency-independent coulomb force. Inserting the latter term into equation (2) shows that the sound pressure is not dependent upon the frequency.

Similarly, it can be shown that a frequency response of the sound pressure which increases by 12 dB/octave is obtained in rigidity-inhibited systems and a frequency response of the sound pressure which increases by 6 dB/octave is obtained in resistance-inhibited systems. Since the impedance of the real systems always contains all three components (mass m, rigidity S or flexibility C and active resistance R), the frequency response of the transducer always has three more or less distinctly recognizable areas. This is illustrated particularly in FIG. 2 which shows a typical frequency response of an ultrasonic transducer. At low frequencies for which Z_{M}=1/ω·C>>ω·m, the frequency response increases by 12 dB/octave.

At higher frequencies, where ω·m>>1/ω·C, the frequency response is horizontal. In the short transitional area where the reactive impedance components compensate one another, an increase in the frequency response of 6 dB/octave is observed.

Consequently, when developing a broadband radiator the resonant frequency of the oscillating system must lie at the lower limit of the desired frequency range. Since the resonant frequency is determined by the product of m·C, there is accordingly a certain freedom in the selection of mass and flexibility. Obviously, the flexibility of the system must be as great as possible because only then can the condition ω·m>>1/ω·C be met at minimum mass m. Thus, for a mass-inhibited system, the rigidity component rather than the mass impedance must be as high as possible. Only in this way can high velocity and, ultimately, high sound pressure be achieved.

The question of the mechanical stability of the diaphragm must be considered at this point. The coulomb forces between the backplate and the diaphragm which move the diaphragm are very weak and decrease by the square of the air gap. For this reason, the air gap must be as small as possible. Further, high sound pressures are achieved only when the oscillating surface of the diaphragm is sufficiently large. These two requirements (a broadband transducer also requires the least possible rigidity of the system) conflict because a large-area diaphragm can be attracted by the backplate and lose the ability to oscillate (and consequently to radiate). In known electrostatic ultrasonic transducers, the problem is solved by means of supporting elements at the inner surface of the backplate. Elements of this type can be webs or columns as in L. Pizarro, D. Certon, M. Lethiecq, O. Boumatar, B. Rosten, “Experimental Investigation of Electrostatic Ultrasonic Transducers with Grooved Backplates”, 1997 IEEE ULTRASONIC SYMPOSIUM-1003, and Michael J. Anderson and James A. Hill, “Broadband electrostatic transducers: Modeling and experiments, J. Acoust. Soc. Am. 97 (1), January 1995.

Ultrasonic transducers in which the diaphragm lies directly on the roughened surface of the backplate are also well known. In all of these cases, the diaphragm is divided into many small radiating zones. Transducers of this type work with substantially higher polarization voltages and signal voltages due to the increased mechanical stability. The sound pressure that can be achieved is also correspondingly high.

A construction of the ultrasonic transducer which meets all of the above-formulated requirements most fully was described in H.-J. Griese, “Transducers for Ultrasonic Remote Controls” [Wandler für Ultraschall-Fernsteuerungen], Funkschau 1973, Volume 9. In this multi-support transducer, the diaphragm is supported on small insulating disks which are uniformly distributed on the finely perforated backplate. In this case, the height of the disks determines the air gap between the backplate and diaphragm. An electroplated nickel sheet (thickness approximately 60μ, perforations approximately 80μ, pitch 250μ) which is produced for filter technology and razors was used as backplate. Since the backplate is perforated, the rigidity of the air between the diaphragm and backplate is no longer a factor. The total rigidity of the system is determined only by the diaphragm rigidity and can be so low that the system can be constructed as a mass-inhibited system already after 40 kHz.

Accordingly, two goals are pursued in the construction of the ultrasonic transducers, namely, the lowest possible losses of diaphragm surface capable of oscillation caused by the supporting structure and the most effective excitation of the diaphragm over the entire surface if possible.

Therefore, an object of the present invention is to provide an improved ultrasonic transducer.

This object is met by an ultrasonic transducer according to claim 1 and by a loudspeaker with at least one ultrasonic transducer according to claim 6.

Accordingly, an ultrasonic transducer with a diaphragm and an embossed backplate is provided.

Due to the fact that the backplate is embossed, there is no longer a need for the spacer disks described above and the efficiency of the transducer is substantially increased.

According to a construction of the invention, the backplate has an approximately sine-shaped profile in cross section.

According to another construction of the invention, the spacing between the diaphragm and the surface of the backplate is substantially sine-shaped.

According to another construction of the invention, the backplate has at least one trapezoidal element in cross section.

According to a preferred construction of the invention, the embossed backplate has raised portions such that an air gap between the diaphragm and the raised portions of the backplate is less than the height of the raised portions.

The invention is likewise directed to a loudspeaker with a plurality of ultrasonic transducers according to the above description.

Further aspects of the invention are the subject matter of the dependent claims.

The invention will be described more fully in the following with reference to the accompanying drawings.

FIG. 1 shows the curve of the sound pressure;

FIG. 2 shows a typical frequency response of an ultrasonic transducer;

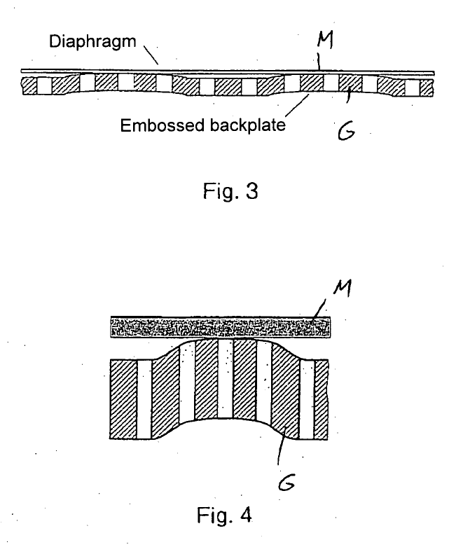

FIG. 3 shows a basic construction of the ultrasonic transducer with embossed backplate according to the first embodiment example;

FIG. 4 shows an enlarged section from FIG. 3;

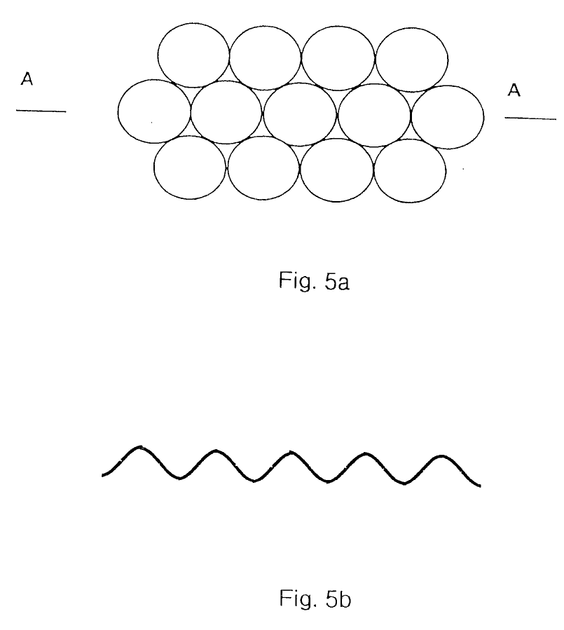

FIG. 5a shows a top view of the backplate according to the first embodiment example;

FIG. 5b shows a cross section through the backplate according to the first embodiment example;

FIG. 6 shows an exterior view of a miniature transducer;

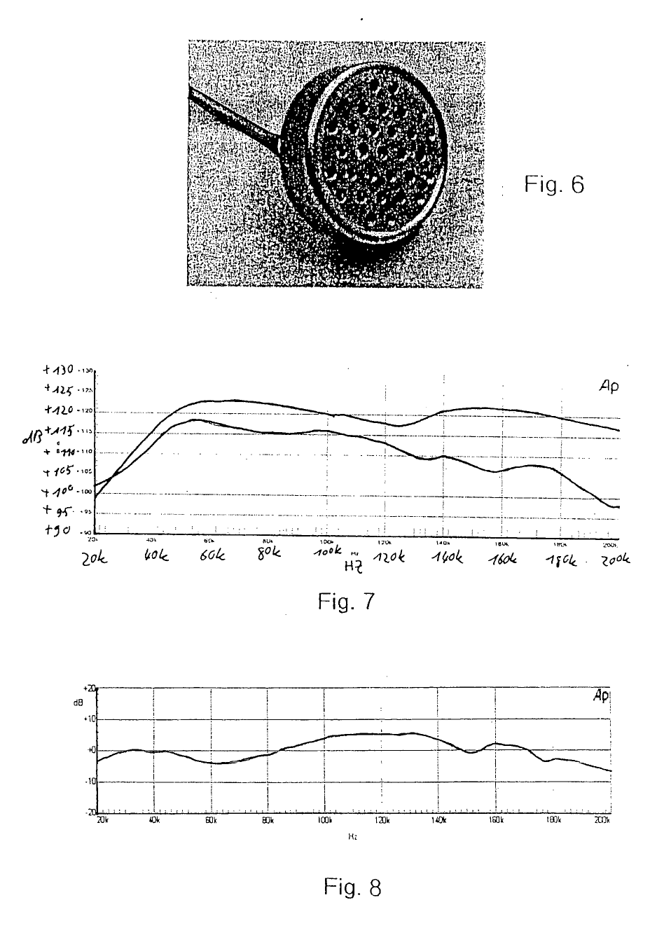

FIG. 7 shows an amplitude frequency response of the miniature transducer from FIG. 6;

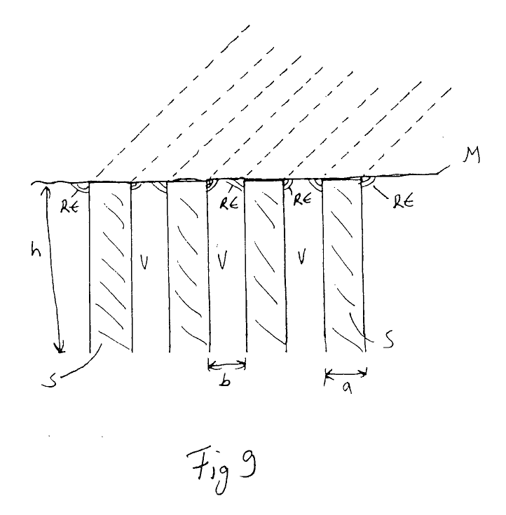

FIG. 8 shows an amplitude frequency response; and

FIG. 9 shows the basic construction of an ultrasonic transducer according to the second embodiment example.

A highly simplified construction of an ultrasonic transducer according to the first embodiment example is shown in FIG. 3. An embossed backplate G and a diaphragm M are shown. It can be seen from FIG. 3 that the raised portions have relatively large surfaces. Since the diaphragm M ideally only lies on the highest points of the raised portions, the losses in diaphragm surface capable of oscillation are identical to those in multi-support transducers. However, as concerns the excitation forces, the variant with the embossed backplate has substantial advantages because the air gap between the diaphragm M and backplate G in the area of the raised portions is less than the height of the raised portions. The excitation forces in these areas are obviously substantially higher than in the areas between the raised portions and therefore the transducer efficiency increases. Due to the optimal and precise embossing of the backplate, multi-support transducers can not only be substantially simplified (spacer disks are no longer needed), but their efficiency can also be substantially increased.

FIG. 4 shows an enlarged section from FIG. 3. In this case, a raised portion or element of the backplate G is shown in an enlarged view. The air gap between the raised portion and the diaphragm M is less than the height of the raised portions.

FIGS. 5a and 5b show a preferred geometry of the backplate. In FIG. 5a, the hexagonal (densest) distribution of embossed raised portions is shown as an example. FIG. 5b shows the cross section A-A with a sine-shaped geometry of the supporting multi-point structure which presents a sine-shaped curve. Greater forces than those in known ultrasonic transducers act on the entire surface of the diaphragm. In the areas between the raised portions where the diaphragm excursion is greatest, the distance between the diaphragm and backplate remains sufficient to prevent the diaphragm from slapping against it.

The raised portions must absolutely be rounded at the top because the pointed shape leads to electrical puncturing of the diaphragm.

Of course, the embossing of the backplate can also be trapezoidal, which is advantageous for transducers for the frequency range of 30 to 50 kHz.

In the examples shown above, a metallized plastic diaphragm M lies directly on the raised portions of the backplate. The plastic diaphragm can be, e.g., PET foil, PI foil and Teflon foil and has a very high resistance to puncture. With 3μ Mylar diaphragm, for example, the maximum permissible voltage is about 300 V.

The newly developed embossing technology allows a precise, optimal shaping of the raised portions not only for small transducers but also for large-area transducers (up to DIN A3). For AudioBeam applications, a transducer with dimensions of 20×30 cm or 182×289 mm can be produced.

An embossed perforated plate can be glued to a pre-cut aluminum plate. An aluminum frame with the glued diaphragm is connected to the backplate by plastic screws. In the edge area, a protective foil must absolutely be provided between the diaphragm frame and the perforated plate.

The frequency response of the transducer (measured at 200 VDC and 100 VAC) has very high sound pressures in the broad frequency range of the transducer.

Of course, transducers which are not absolutely planar could also be produced. This could be advantageous, for example, when a very high directivity of the ultrasonic transducer is not desirable.

FIG. 6 shows another example with a smaller transducer having a diameter of 14.5 mm and a height of 4.7 mm.

FIG. 7 shows two frequency responses (20 kHz to 200 kHz) of the transducer with and without perforated grating from FIG. 6. Reception was carried out with a B&K measurement microphone 4138 without a protective grating. Measurements were taken at a distance of 10 cm at 200V polarization voltage and 120V signal voltage. The effective radiating surface of the transducer was 0.93 cm² and the transducer capacitance was around 60 pF.

In FIG. 7, the upper curve represents a transducer without a perforated grating. The typical frequency response curve mentioned above is easily discernable in this curve. The achievable sound level is over 120 dB SPL. The bottom curve was measured for a transducer with a perforated grating corresponding to FIG. 6.

Since a broadband receiver is necessary for many applications, a corresponding electret microphone can also be provided. The microphone has a sensitivity of about 1 mV/Pa and its frequency response is shown in FIG. 8. The same housing as that shown in FIG. 6 is used for this microphone.

The directivity diagrams are deliberately omitted. They can easily be calculated from the transducer geometry and the wavelength relationships.

Finally, it must be emphasized that for the first time an optimized pair of broadband transducers (transmitter and receiver) which are tuned or adapted to one another can be provided which offers ideal preconditions for numerous new applications.

Of course, cylindrically curved transducers, for example, can also be produced with this technique. This may be advantageous when the very high directivity of the ultrasonic transducer is not desirable.

The data and equations given above allow the sound pressure in the far field to be calculated for practically any transducer sizes.

FIG. 9 shows a basic construction of an ultrasonic transducer according to a second embodiment example, The backplate G of the ultrasonic transducer has webs S over which a diaphragm M is provided. To this extent, the basic construction corresponds to the construction from FIG. 3. The webs S have a width a and are at a distance b from one another, so that there is a volume V filled with air in the space between two adjacent webs S. The webs S are preferably made from a conductive material such as aluminum, for example. Alternatively, the webs S can likewise be manufactured from a nonconducting material such as plastic when they are to be coated subsequently with a conductive layer, i.e., metallization is carried out. The diaphragm M can be a foil such as is described in the first embodiment example.

The surface of the webs S located opposite the diaphragm M is preferably rough.

Those portions of the diaphragm arranged above the intermediate spaces between the webs S do not contribute to the effective excitation of the diaphragm in the first approximation. Accordingly, it is desirable to minimize the spacing between the webs as much as possible. The webs S have a corresponding height h in order to take into account the air in the volume V between the webs S.

In other words, the desired coulomb forces can act only at the locations between the webs S and the diaphragm M. However, an interaction between webs S and diaphragm M also occurs at the edges of the webs S because of edge or fringe effects RE. These fringe effects RE are desirable because they contribute to driving due to the interaction or the coulomb forces. Therefore, the fringe effects RE help to minimize losses. The selected distance b between the webs S can be small enough that the fringe effects RE sweep over the distance b, i.e., the fringe effects RE of two oppositely located webs S project into or act in the gap between the two webs S to the extent that they contact or bridge the gap. Accordingly, it is advantageous to reduce or minimize the distance in order to obtain a maximum driving force. Further, it is advantageous to increase the height h of the webs S and, therefore, the depth of the gap simultaneously when reducing the distance b between the webs S. In this way, the volume of the gap can be kept substantially constant and sufficiently large so as not to impair to too great a degree the ability of the diaphragm to oscillate.

As was described in the first embodiment example, the cross section of the webs in the upper area can be trapezoidal or substantially sinusoidal or rounded in the upper area. Further in this regard, sharp edges should be avoided in order to prevent the high field strength in a corresponding manner.

The webs S can have a width a of 100 μm and a spacing b of 20 μm between them, for example. The height h of the webs can be, e.g., 100 μm.

The webs S can be constructed as straight lines or as concentric circles. Other arrangements are also possible.

By providing the webs S with an appropriate width, a required excitation force and, therefore, high efficiency can be ensured. Further, the ability of the diaphragm M to oscillate can be ensured by providing the spaces between the webs S.

The ultrasonic transducers described above can be used, for example, in movement sensors, distance sensors, anemometers or flow meters.

1-8. (cancelled).

9. An ultrasonic transducer comprising a diaphragm and an embossed backplate.

10. The ultrasonic transducer according to claim 9, wherein the backplate has an approximately sine-shaped profile in cross section.

11. The ultrasonic transducer according to claim 10, wherein the spacing between the diaphragm and the surface of the backplate is substantially sine-shaped.

12. The ultrasonic transducer according to claim 9, wherein the backplate has at least one trapezoidal element in cross section.

13. The ultrasonic transducer according to claim 9, wherein the embossed backplate has raised portions such that an air gap between the diaphragm and the raised portions of the backplate is less than the height of the raised portions.

14. The ultrasonic transducer according to claim 9, wherein the backplate has a plurality of webs (S) which have a height (h) and are spaced at a distance (b) from one another.

15. The ultrasonic transducer according to claim 14, wherein the distance (b) between two adjacent webs (S) is selected in such a way that fringe effects (RE) occurring at the edge of the adjacent webs (S) bridge the distance (b).

16. A loudspeaker with at least one ultrasonic transducer according to claim 9.
